(19) United States
(12) Patent Application Publication
(10) Pub. No.: US 2026/0187506 A1
(43) Pub. Date: Jul. 2, 2026

(54) QUANTUM COMPUTATIONAL SOFTWARE PRIMITIVE FOR GENERAL QUANTUM CHANNELS

(71) Applicant: International Business Machines Corporation, Armonk, NY (US)

(72) Inventors: Derek Wang, New York, NY (US); Pedro Rivero Ramirez, Long Island City, NY (US); Iskandar Sitdikov, New York, NY (US)

(21) Appl. No.: 19/007,814

(22) Filed: Jan. 2, 2025

(51) Int. Cl. G06N 10/20

(52) U.S. Cl. CPC G06N 10/20

(57) ABSTRACT

Systems/techniques that facilitate a quantum computational software primitive for general quantum channels are provided. In various embodiments, a system can comprise a processor that executes computer executable components stored in a memory. In various aspects, the computer executable components can comprise an input component that receives a quantum channel circuit. In various embodiments, the computer executable components can further comprise a decomposition component that decomposes one or more quantum channels in the quantum channel circuit into an ensemble of quantum circuits. In various instances, the computer executable components can further comprise an execution component that executes, on a quantum system, the ensemble of quantum circuits. In various embodiments, the computer executable components can further comprise a computation component that determines a probability distribution of the one or more quantum channels based on the executing of the ensemble of quantum circuits.

### BACKGROUND

The subject disclosure relates to quantum computing, and more specifically to a quantum computational software primitive for general quantum channels.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate a quantum computational software primitive for general quantum channels are described.

According to one or more embodiments, a system is provided. In various aspects, the system can comprise a memory that stores computer executable components. In various embodiments, the system can further comprise a processor executes the computer executable components stored in the memory, wherein the computer executable components can comprise an input component that receives a quantum channel circuit. In various instances, the computer executable components can further comprise a decomposition component that decomposes one or more quantum channels in the quantum channel circuit into an ensemble of quantum circuits. In various cases, the computer executable components can further comprise an execution component that executes, on a quantum system, the ensemble of quantum circuits. In various embodiments, the computer executable components can further comprise a computation component that determines a probability distribution of the one or more quantum channels based on the executing of the ensemble of quantum circuits.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates a quantum computational software primitive for general quantum channels in accordance with one or more embodiments described herein.

FIG. 2 illustrates another block diagram of an example, non-limiting system that facilitates a quantum computational software primitive for general quantum channels in accordance with one or more embodiments described herein.

FIG. 3 illustrates a block diagram of an example, non-limiting system showing parameterized decomposition of a quantum channel circuit in accordance with one or more embodiments described herein.

FIG. 4 illustrates an example, non-limiting block diagram showing how a quantum channel circuit is decomposed into an ensemble of quantum circuits in accordance with one or more embodiments described herein.

FIG. 5 illustrates an example, non-limiting base code implementation for a quantum computational software primitive for general quantum channels in accordance with one or more embodiments described herein.

FIG. 6 illustrates an example, non-limiting block diagram of an example application for readout mitigation in accordance with one or more embodiments described herein.

FIG. 7 illustrates an example, non-limiting block diagram of an example application for twirling in accordance with one or more embodiments described herein.

FIG. 8 illustrates an example, non-limiting block diagram of an example application for compensation in accordance with one or more embodiments described herein.

FIG. 9 illustrates an example, non-limiting block diagram of an example application for inversion in accordance with one or more embodiments described herein.

FIG. 10 illustrates an example, non-limiting block diagram of an example application for noise amplification in accordance with one or more embodiments described herein.

FIG. 11 illustrates an example, non-limiting block diagram of an example application for partial folding in accordance with one or more embodiments described herein.

FIG. 12 illustrates an example, non-limiting block diagram of an example application for circuit cutting in accordance with one or more embodiments described herein.

FIG. 13 illustrates a flow diagram of an example, non-limiting computer-implemented method that facilitates a quantum computational software primitive for general quantum channels in accordance with one or more embodiments described herein.

FIG. 14 illustrates a flow diagram of an example, non-limiting computer-implemented method that facilitates a quantum computational software primitive for general quantum channels in accordance with one or more embodiments described herein.

FIG. 15 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

According to one or more embodiments, a system is provided. In various aspects, the system can comprise a memory that stores computer executable components. In various embodiments, the system can further comprise a processor executes the computer executable components stored in the memory, wherein the computer executable components can comprise an input component that receives a quantum channel circuit. In various instances, the computer executable components can further comprise a decomposition component that decomposes one or more quantum channels in the quantum channel circuit into an ensemble of quantum circuits. In various cases, the computer executable components can further comprise an execution component that executes, on a quantum system, the ensemble of quantum circuits. In various embodiments, the computer executable components can further comprise a computation component that determines a probability distribution of the one or more quantum channels based on the executing of the ensemble of quantum circuits. Such embodiments of the system can provide a number of advantages, including providing user-friendly utility-scale quantum computation, enabling more applications of quantum computing beyond unitary quantum circuits by enabling implementation of general quantum channels, and providing memory-efficient and computationally efficient implementation of general quantum channels.

According to one or more embodiments of the aforementioned system, the decomposition component can receive parameters for decomposing the one or more quantum channels, wherein the parameters comprise a time limit for classical processing or decomposition settings. Such embodiments of the system can provide a number of advantages, including improving a balance between computational efficiency and accuracy and enabling user-accessible customization for circuit decomposition.

According to one or more embodiments of the aforementioned system, the decomposition component can decompose the one or more quantum channels globally across all of the one or more quantum channels in the quantum channel circuit. According to one or more embodiments of the aforementioned system, the decomposition component can decompose the one or more quantum channels locally, wherein each of the one or more quantum channels are decomposed into a set of quantum circuits. Such embodiments of the system can provide a number of advantages, including providing efficient decomposition of general quantum channels.

According to one or more embodiments of the aforementioned system, the decomposition component can customize decomposition by decomposing the one or more quantum channels using parameterized gates. Such embodiments of the system can provide a number of advantages, including providing user-friendly customization for circuit decomposition and reducing noise susceptibility of the ensemble of quantum circuits.

According to one or more embodiments of the aforementioned system, the execution component can execute the ensemble of quantum circuits in an interleaved manner. According to one or more embodiments of the aforementioned system, the execution component can execute the ensemble of quantum circuits in a sequential manner. Such embodiments of the system can provide a number of advantages, including providing user-friendly customization of execution of the ensemble of quantum circuits.

According to one or more embodiments of the aforementioned system, the execution component can execute the ensemble of quantum circuits across one or more quantum processors. Such embodiments of the system can provide a number of advantages, including improving resource utilization and reducing latency of implementing general quantum channels.

According to one or more embodiments of the aforementioned system, wherein the probability distribution can be a quasi-probability distribution. According to one or more embodiments of the aforementioned system, wherein the probability distribution can be expectation values that are user-defined based on the quasi-probability distribution. According to one or more embodiments of the aforementioned system, wherein the computation component can determine, via bootstrapping over shots, confidence intervals or error bars to quantify uncertainty in the quasi-probability distribution or the expectation values. Such embodiments of the system can provide a number of advantages, including enabling user-accessible implementation of general quantum channels.

In various aspects, the above-described system can be reformulated, reformatted, or otherwise implemented as a computer-implemented method or as a computer program product.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computer can be any suitable device that utilizes a qubit lattice (e.g., a plurality of superconducting qubits fabricated on one or more quantum substrates and exhibiting any suitable connection topology) for information processing. A unitary quantum circuit is a quantum circuit composed of a sequence of unitary operations. Currently, quantum computers are only capable of implementing unitary quantum circuits. Quantum computers can only implement unitary quantum circuits because the evolution of a quantum state in a closed quantum system must obey the Schrödinger equation, which requires operations to be unitary to preserve the total probability (norm) of the quantum state. A general quantum channel describes the most general evolution of a quantum state, including unitary transformations, noise, and measurements. That is, a general quantum channel is a quantum computational operation that cannot be simulated by a single, unitary quantum circuit. Therefore, general quantum channels cannot be implemented directly on quantum computers. General quantum channels provide a wide range of applications, such as modelling noise in quantum systems, open system simulations, or quantum error mitigation. However, since general quantum channels are not directly implementable on quantum computers, quantum computing is constrained to unitary operations, limiting its ability to natively simulate non-unitary and, consequently, its range of applications.

One way to simulate general quantum channels on the hardware of quantum computers is by superimposing ensembles of unitary quantum circuits and sampling a quasi-probability distribution. The quasi-probability distribution is a probability distribution that can have negative probability density. In the context of quantum computing, the quasi-probability distribution can enable computation of various useful and interesting properties of quantum mechanical systems.

However, implementing general quantum channels by superimposing ensembles of unitary quantum circuits is not currently user-friendly, accessible, or efficiently implementable. More specifically, existing techniques for implementing general quantum channels on quantum computers involve intricate constructions of composite circuits that can emulate non-unitary processes. Such existing techniques involve combining multiple unitary operations to approximate the effects of noise, dissipation, or other non-unitary transformations, which can be computationally intensive and difficult to implement efficiently. Existing methods fall short of providing an intuitive or streamlined approach to implementing general quantum channels, as users must focus more on the technical aspects of workload distribution, circuit generation, and hardware optimization. As a result, users are often required to engage with low-level details rather than focusing on higher-level applications and algorithms. Additionally, the complexity of managing these ensembles increases with the scale of the system, making it less user-friendly and accessible. As a result, despite the potential of such approaches, these existing techniques remain impractical for many users, limiting their application in practical quantum computing scenarios.

Other existing techniques implement general quantum channels on quantum computers by decomposing quantum channels using parameterized single-qubit gates. However, these other existing techniques cannot be applied to all quantum channels (e.g., all general quantum channels). Furthermore, some existing techniques utilize cloud-hosted quantum processing units (QPUs), which can be memory-inefficient since the input streamed into the cloud-hosted QPU will occupy larger memory footprints.

In various instances, quantum computational software primitives can be used to enable more user-accessible quantum computing. A quantum computational software primitive (e.g., an algorithmic primitive) is a computational building block that can be used in larger applications whose input units require quantum resources to efficiently produce outputs for. In other words, quantum computational software primitives serve as fundamental operations that allow users to harness the power of quantum resources efficiently. By utilizing quantum computational software primitives, users can access computational nodes that perform tasks at a high level of performance, taking advantage of quantum processing capabilities to solve complex problems more efficiently. These quantum computational software primitives are essential for building quantum algorithms and applications, providing the necessary building blocks for quantum computations that require specialized resources like quantum gates or entanglement to users.

For example, some GPUs can have algorithmic primitives that, upon receiving a user task, manage the hardware and efficiently distribute the task across the various components of the hardware. Similarly in quantum computing, QPUs can have various algorithmic primitives. For example, algorithmic primitives can be used as computational building blocks in software stacks for quantum computing such as Qiskit. Some existing algorithmic primitives in Qiskit include “Sampler” and “Estimator”. As algorithmic primitives, “Sampler” and “Estimator” can both receive input from a user for performing a quantum computing task and efficiently generate output. For instance, the “Sampler” can receive a quantum circuit as input and generate a probability distribution over bitstrings as output. As another example, the “Estimator” can receive a quantum circuit and observables as input and generate expectation values of the observables as output. Although these algorithmic primitives provide user-friendly access for carrying out quantum computational tasks, such algorithmic primitives cannot be generalized for implementing general quantum channels. More specifically, such algorithmic primitives utilize parameterized single-qubit gates, and as previously discussed, parameterized single-qubit gates cannot be used to simulate general quantum channels (e.g., only certain quantum channels can be simulated using parameterized single-qubit gates).

The various techniques described herein can help to address or ameliorate various of the above-described technical problems that plague existing techniques for implementing general quantum channels on quantum computers. In particular, the various embodiments described herein can provide a quantum computational software primitive for implementing general quantum channels on quantum computers so as to help solve such technical problems.

Specifically, various embodiments described herein can involve receiving a quantum channel circuit (e.g., a quantum circuit with a quantum channel) as input and decomposing one or more quantum channels in the quantum channel circuit into an ensemble of quantum circuits. Thereafter, the various embodiments described herein can execute, on a quantum system (e.g., a quantum computer), the ensemble of quantum circuits to produce a probability distribution of the one or more quantum channels as output.

Furthermore, the various embodiments can receive various settings or parameters as input (e.g., from user input) to customize the decomposition process of the quantum channel circuit into the ensemble of quantum circuits. For example, the settings can comprise time limits for decomposing the quantum channel circuit to improve efficiency while balancing accuracy. As another example, the settings can include different decomposition options, such as global decomposition or local decomposition. Various embodiments described herein can also facilitate efficient execution of the ensemble of quantum circuits. Specifically, execution of the ensemble of quantum circuits can be distributed across multiple QPUs to optimize resource utilization, improve processing efficiency, and reduce latency. Thus, users can provide such settings and parameters to have more control over the implementation of the quantum channel circuit without having to focus on hardware optimization or workload distribution. That is, various embodiments described herein are able to efficiently implement a quantum channel circuit in a user-friendly and customizable manner. Additionally, the various embodiments described herein can be integrated into any suitable software stacks (e.g., such as Qiskit) to expand quantum computing to various other applications that were previously limited (e.g., unavailable or unimplementable due to the inability to implement non-unitary operations) to users.

Accordingly, various embodiments described herein can be considered as concrete technical improvements in implementing general quantum channels.

Various embodiments described herein can be employed to use hardware or software to solve problems that are highly technical in nature (e.g., to facilitate a quantum computational software primitive for general quantum channels), that are not abstract and that cannot be performed as a set of mental acts by a human. Further, some of the processes performed can be performed by a specialized computer (e.g., quantum computers comprising tangible qubits that can execute or implement quantum circuits; quantum software primitives for executing quantum computational tasks on a quantum computer).

Neither the human mind nor a human with pen and paper can: electronically access or receive a quantum channel circuit; electronically decompose one or more channels in the quantum channel circuit into an ensemble of quantum circuits; electronically execute the ensemble of quantum circuits on a quantum system; electronically generate a probability distribution based on the execution of the ensemble of quantum circuits; or electronically execute the ensemble of quantum circuits in parallel across multiple QPUs. After all, a quantum computer is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum computer. Neither the human mind, nor a human with pen and paper, can transpile or otherwise manipulate quantum gates or execute quantum gates on physical qubits. Also, the very field of quantum channel circuits is focused on electronically simulating quantum channel circuits so that they can be implementable or executable on a quantum hardware. Additionally, the very field of quantum computational software primitives are focused on electronically enabling user-friendly or accessible quantum task execution. It would make no sense whatsoever to discuss the fields of quantum channel circuits or quantum computational software primitives outside of a computing context. Therefore, a computerized tool that can facilitate a quantum computational software primitive for general quantum channels is inherently computerized and cannot be implemented in any sensible, practicable, or reasonable way without computers.

In various instances, one or more embodiments described herein can integrate the herein-described teachings into a practical application. As mentioned above, some existing techniques can facilitate implementation of a quantum channel on quantum computer. Unfortunately, such existing techniques cannot be applied to any general quantum channel and cannot implement the quantum channel efficiently. As also mentioned above, other existing techniques do not provide a user-friendly or accessible way for simulating a general quantum channel as an ensemble of quantum circuits and executing the ensemble of quantum circuits. Thus, such other existing techniques nevertheless suffer from various technical problems.

Accordingly, the various embodiments described herein can be considered as solving, addressing, or otherwise ameliorating the technical problems that afflict such existing techniques. In particular, various embodiments described herein can include enabling implementation of any general quantum channel through a quantum computational software primitive. More specifically, when given a quantum channel circuit having one or more quantum channels, various embodiments described herein can involve decomposing the one or more quantum channels into an ensemble of quantum circuits and executing the ensemble of quantum circuits to produce a probability distribution of the one or more quantum channels. Further, the various embodiments described herein can receive parameters or settings as input to allow customizable decomposition or execution. Contrast this with existing techniques, that instead require unwieldy decompositions of a quantum channel into individual quantum circuits with no user-accessible interface. Thus, by implementing a quantum computational software primitive for general quantum channels, various embodiments described herein can facilitate implementation of general quantum channels more efficiently, with more customizations, and with more possible quantum computing applications than existing techniques. For at least these reasons, various embodiments described herein constitute concrete and tangible technical improvements or technical effects in the field of implementing general quantum channels and thus certainly qualify as useful and practical applications of computers.

It should be appreciated that the figures and the herein disclosure describe non-limiting examples of various embodiments. It should further be appreciated that the figures are not necessarily drawn to scale.

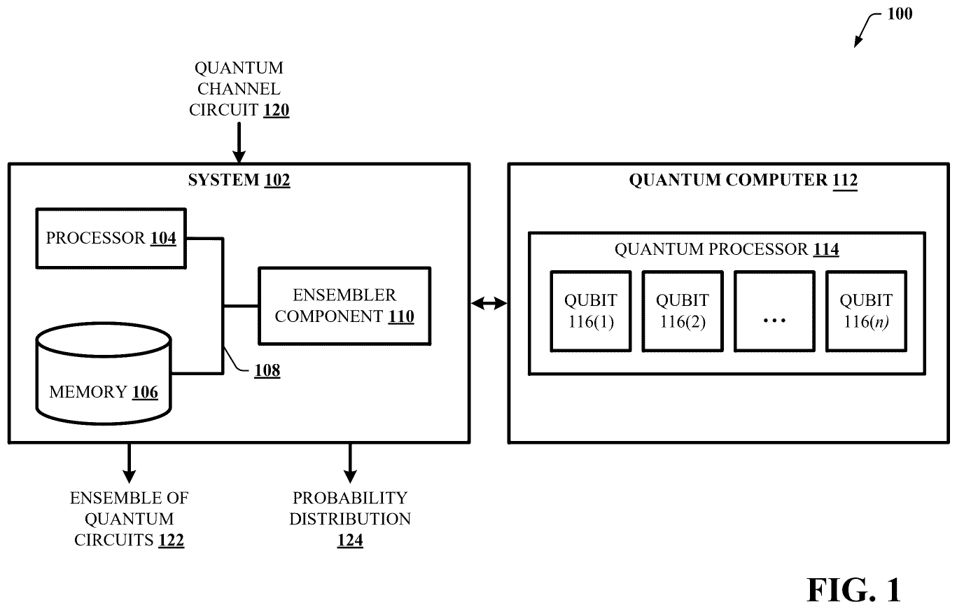

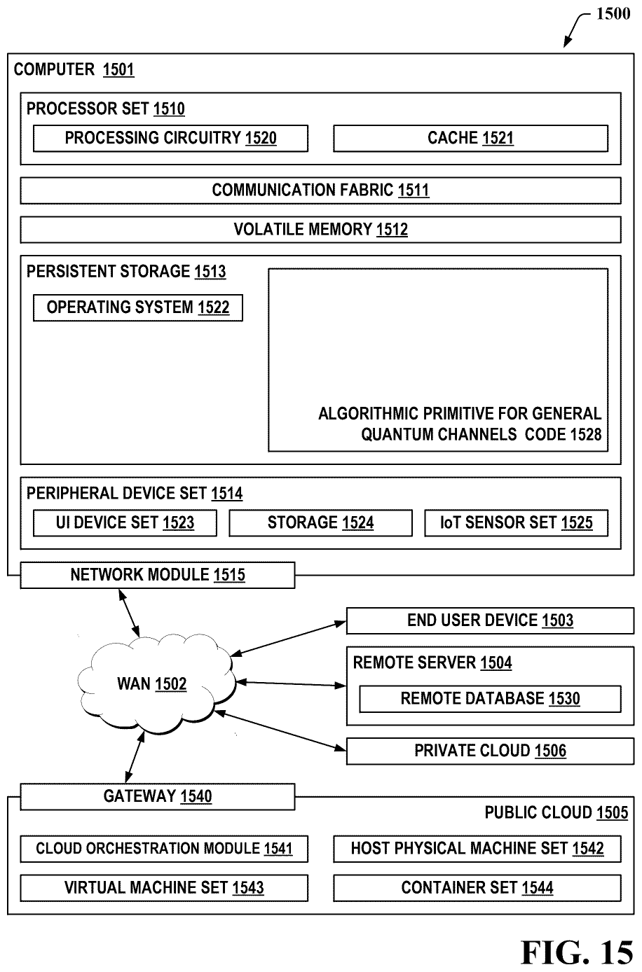

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1500 illustrated at FIG. 15. For example, non-limiting system 100 can be associated with, such as accessible via, a computing environment 1500 described below with reference to FIG. 15, such that aspects of processing can be distributed between non-limiting system 100 and the computing environment 1500. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate a quantum computational software primitive for general quantum channels in accordance with one or more embodiments described herein. As shown, a classical system 102 can be electronically integrated, via any suitable wired or wireless electronic connections, with a quantum computer 112 or with a quantum channel circuit 120.

Discussion turns briefly to processor 104, memory 106 and bus 108 of non-limiting system 100. For example, in one or more embodiments, non-limiting system 100 can comprise processor 104 (e.g., computer processing unit, microprocessor, classical processor, and/or like processor). In one or more embodiments, a component associated with non-limiting system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, non-limiting system 100 can comprise a computer-readable memory (e.g., memory 106) that can be operably connected to processor 104. Memory 106 can store computer-executable instructions that, upon execution by processor 104, can cause processor 104 and/or one or more other components of non-limiting system 100 (e.g., ensembler component 110, input component 202, decomposition component 204, execution component 206, and/or computation component 208) to perform one or more actions. In one or more embodiments, memory 106 can store computer-executable components (e.g., ensembler component 110, input component 202, decomposition component 204, execution component 206, and computation component 208).

Non-limiting system 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, non-limiting system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of non-limiting system 100 can reside in the cloud, and/or can reside locally in a local computing environment (e.g., at a specified location(s)).

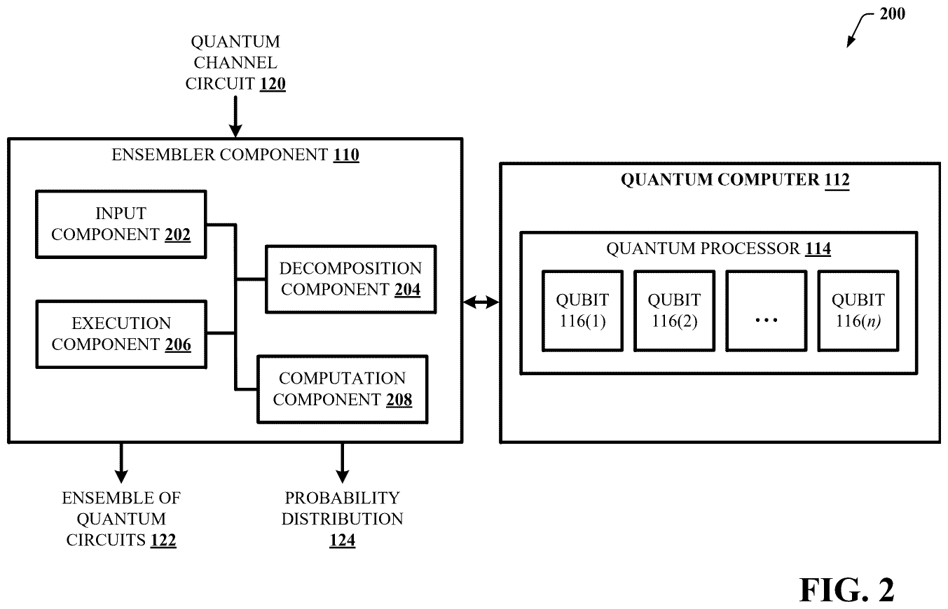

In various embodiments, ensembler component 110 can comprise input component 202, decomposition component 204, execution component 206, and computation component 208, as illustrated in FIG. 2.

As illustrated in FIG. 1, non-limiting system 100 can comprise classical system 102 and quantum computer 112. That is, the non-limiting system 100 can facilitate a quantum computational software primitive for general quantum channels, in combination with employment of the quantum computer 112. Classical system 102 can be coupled (operatively, communicatively, electrically, and/or like function) to quantum computer 112.

In various embodiments, the quantum computer 112 can be any suitable quantum computing device or quantum computing hardware. In various aspects, the quantum computer 112 can comprise or otherwise include a quantum processor 114. The quantum processor 114 can comprise a set of qubits 116. In various instances, the set of qubits 116 can have n qubits for any suitable positive integer n: a qubit 116(1) to a qubit 116(n). In various cases, any of the set of qubits 116 can exhibit any suitable structure or architecture. As a non-limiting example, any of such qubits can exhibit a superconducting qubit architecture (e.g., such qubit can be constructed from any suitable number of Josephson junctions shunted by any suitable number of planar capacitor pads). As another non-limiting example, any of such qubits can exhibit a quantum dot architecture. As yet another non-limiting example, any of such qubits can exhibit a spin qubit architecture. In various aspects, different qubits of the set of qubits 116 can exhibit the same or different structures or architectures as each other. Although not explicitly shown in FIG. 1, the quantum computer 112 can comprise or otherwise be associated with any suitable hardware or software (e.g., real-time controllers implemented in field programmable gate arrays of the quantum computer 112) that can be used to initialize any of the set of qubits 116, or that can be used to perform any suitable quantum operations (e.g., quantum gates, qubit measurements, qubit idling) on the set of qubits 116.

In various aspects, the input component 202 can electronically access, in any suitable fashion, the quantum computer 112, such that the classical system 102 can electronically activate (e.g., power-up), electronically deactivate (e.g., power-down), or otherwise electronically control the quantum computer 112. Furthermore, in various instances, the input component 202 can electronically receive, retrieve, obtain, import, or otherwise access, from any suitable data structures or from any suitable computing devices, the quantum channel circuit 120. In any case, the input component 202 can electronically access (e.g., send or receive data or program instructions to or from) the quantum computer 112 or the quantum channel circuit 120, such that other components of the classical system 102 can electronically interact with the quantum computer 112 or with the quantum channel circuit 120.

In various instances, the quantum channel circuit 120 can be any suitable quantum circuits that comprises or otherwise includes one or more quantum channels (e.g., quantum channels 302).

In any case, it can be desirable to simulate the quantum channel circuit 120 with an ensemble of quantum circuits 122. That is, it can be desirable to simulate the quantum channel circuit into a format that is supported by, implementable on, or executable on the quantum computer 112. As described herein, the classical system 102 can facilitate such simulation or implementation.

Furthermore, the classical system 102 can facilitate execution of the ensemble of quantum circuits 122 on the quantum computer 112 to produce a probability distribution 124 of the quantum channel circuit 120 as output.

FIG. 2 illustrates another block diagram of an example, non-limiting system 200 that facilitates a quantum computational software primitive for general quantum channels in accordance with one or more embodiments described herein.

In various embodiments, the decomposition component 204 can, as described herein, decompose the quantum channel circuit 120 into a one or more quantum circuits that are implementable or executable on quantum computer 112 (e.g., one or more unitary quantum circuits). The one or more quantum circuits can be considered the ensemble of quantum circuits 122.

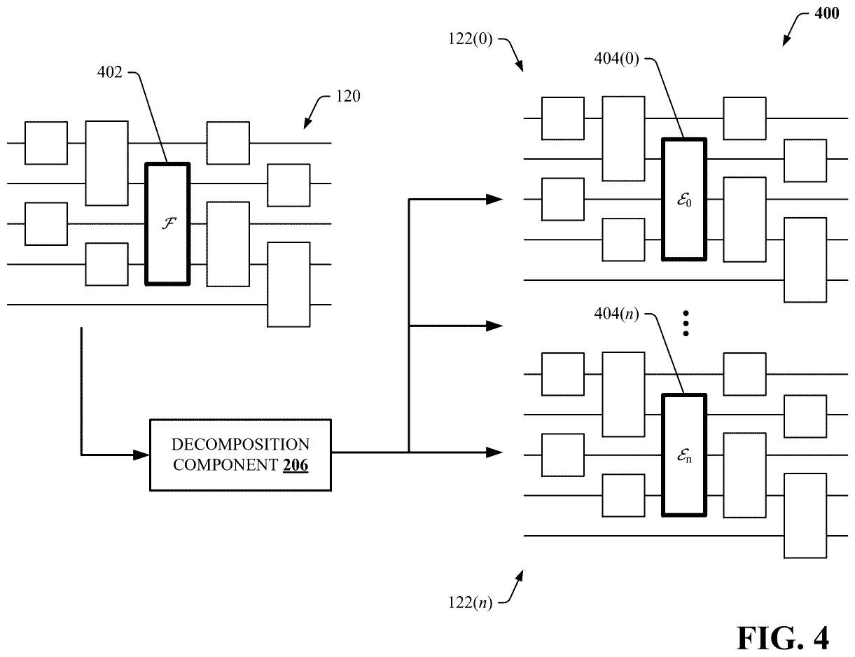

In various aspects, the decomposition component 204 can utilize any suitable method to decompose the quantum channel circuit 120 into the ensemble of quantum circuits 122. As a non-limiting example, the decomposition component 204 can utilize quasi-probability decomposition (QPD) to decompose the quantum channel circuit 120 into the ensemble of quantum circuits 122. Such non-limiting example is further discussed with respect to FIG. 4.

In various instances, the execution component 206 can, as described herein, cause the ensemble of quantum circuits 122 to be executed or performed by the quantum computer 112. In this way, the quantum channel circuit 120 can be simulated by the ensemble of quantum circuits 122 for executing or performing by the quantum computer 112. That is, such execution can be considered as indirectly implementing the quantum channel circuit 120 on the quantum computer 112. In various aspects, the execution component 206 can execute each of the ensemble of quantum circuits 122 in a parallelizable manner. For instance, the execution component 206 can distribute each of the ensemble of quantum circuits 122 across more than one quantum processor for execution. That is, the execution of each of the ensemble of quantum circuits 122 can be performed in parallel on different quantum processors.

In any case, in various aspects, the execution of each of the ensemble of quantum circuits 122 can yield respective execution results. In various embodiments, the computation component 208 can, as described herein, access the respective execution results for each of the ensemble of quantum circuits 122 and combine the respective execution results to produce the probability distribution 124 of the quantum channel circuit 120 as output.

In various cases, a user can input a desired type of output. For instance, the computation component 208 can output probability distribution 124 as a quasi-probability distribution. In other instances, a user can define and input complex expectation values. Accordingly, based on such input, the computation component 208 can output probability distribution 124 as complex expectation values based on the quasi-probability distribution.

In various instances, the computation component 208 can determine confidence intervals to quantify uncertainty in the quasi-probability distribution or the expectation values. In other instances, the computation component 208 can determine error bars to quantify uncertainty in the quasi-probability distribution or the expectation values. To achieve this in either case, the computation component 208 can perform bootstrapping over shots of executing the ensemble of quantum circuits 122. No matter the type of output, the computation component 208 can output the probability distribution 124 (and any additional data or information).

Note that, in various instances, the input component 202, the decomposition component 204, and the execution component 206 can collectively be considered as being ensembler component 110 of the classical system 102. In various aspects, it should be appreciated that the ensembler component 110 are described primarily herein as comprising four components (e.g., the input component 202, the decomposition component 204, the execution component 206, and the computation component 208) for ease of explanation and illustration. However, the ensembler component 110 are not limited to being implemented as exactly such four components in every embodiment. Indeed, in some embodiments, the functionalities described herein of such four components can be combined in any suitable fashions, so as to be implemented in or by fewer than four components (e.g., in some cases, a single component can perform all of the functionalities that are described herein with respect to the input component 202, the decomposition component 204, the execution component 206, and the computation component 208). In other embodiments, the functionalities described herein of such four components can instead be distributed, separated, split, or fragmented in any suitable fashions, so as to be implemented in or by more than four components (e.g., two or more components can facilitate the functionalities that are performable by the input component 202; two or more components can facilitate the functionalities that are performable by the decomposition component 204; two or more components can facilitate the functionalities that are performable by the execution component 206; two or more components can facilitate the functionalities that are performable by the computation component 208).

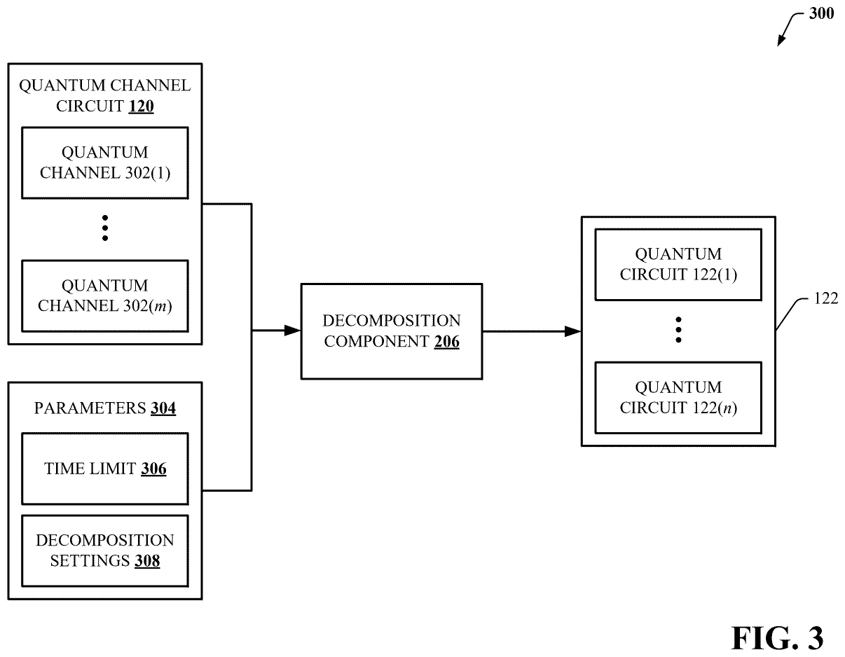

FIG. 3 illustrates a block diagram of an example, non-limiting system 300 showing parameterized decomposition of a quantum channel circuit in accordance with one or more embodiments described herein.

In various embodiments, the quantum channel circuit 120 can comprise, have, or otherwise possess m quantum channels 302 (e.g., general quantum channels), for any suitable positive integer m>1: a quantum channel 302(1) to a quantum channel 302(m). In various aspects, each of the quantum channels 302 can be any suitable quantum channel that cannot be simulated by a single unitary quantum circuit.

In various aspects, the input component 202 can receive a set of parameters 304. In various embodiments, the set of parameters 304 can be any suitable electronic data (e.g., can be one or more scalars, one or more vectors, one or more matrices, one or more tensors, one or more character strings, or any suitable combination thereof) that indicates parameters or settings for implementing the quantum channel circuit 120 on the quantum computer 112 (e.g., for decomposing the quantum channel circuit 120, for executing the ensemble of quantum circuits 122, the desired output from executing the ensemble of quantum circuits 122).

In various instances, the set of parameters 304 can include a time limit 306. In various embodiments, the time limit 306 can define a maximum time that decomposition component 204 can spend to decompose the quantum channels 302 into the ensemble of quantum circuits 122. This way, classical processing for decomposing the quantum channels 302 can be limited to balance computational efficiency with accuracy of decomposition.

In various aspects, the set of parameters 304 can further include decomposition settings 308. In various cases, the decomposition settings 308 can include any suitable settings that can be adjusted or changed to customize the decomposition of the quantum channels 302. In some instances, the decomposition settings 308 can include a parameter that specifies how decomposition is applied to the quantum channels 302.

For example, the parameter can indicate that the quantum channels 302 are to be decomposed locally. More specifically, local decomposition can comprise decomposing each of quantum channels 302 into a respective set of quantum circuits. The collective circuits of the respective set of quantum circuits for each of quantum channels 302 can then be considered the ensemble of quantum circuits 122. In other words, for each quantum channel 302(i), where i is a positive integer such that 1≤i≤m, decomposition component 204 can decompose quantum channel 302(i) into cᵢ quantum circuits. Accordingly, the total number of quantum circuits in the ensemble of quantum circuits 122 can be a product over cᵢ for all of the quantum channels 302.

As another example, the parameter can indicate that the quantum channels 302 are to be decomposed globally. More specifically, local decomposition can comprise decomposing the quantum channel circuit 120 across all of the quantum channels 302.

As still another example, the parameter can indicate that the quantum channels 302 are to be decomposed in a combination of global and local decomposition. For instance, a combination of global and local decomposition can involve locally decomposing a subset of the quantum channels 302 and globally decomposing a remaining subset of the quantum channels 302.

In various aspects, the decomposition settings 308 can further include a parameter that indicates a method for decomposing the quantum channel circuit 120. For instance, the parameter can indicate a heuristic method for decomposing the quantum channel circuit 120. In other instances, the parameter can indicate a brute-force method for decomposing the quantum channel circuit 120. In still other instances, the parameter can indicate a user-defined method for decomposing the quantum channel circuit 120.

Note that, although the set of parameters 304 are discussed as including only time limit 306 and decomposition settings 308, the set of parameters 304 can comprise any other suitable parameters.

In various instances, the set of parameters 304 can further include execution settings for executing the ensemble of quantum circuits 122. For instance, in various cases, the set of parameters 304 can include a parameter indicating in which manner the ensemble of quantum circuits 122 is to be executed with. Specifically, the parameter can indicate that the ensemble of quantum circuits 122 is to be executed in an interleaved manner. In other instances, the parameter can indicate that the ensemble of quantum circuits 122 is to be executed in a sequential manner. Interleaved execution of the ensemble of quantum circuits 122 can be more robust to noise fluctuations in quantum computer 112 while sequential execution of the ensemble of quantum circuits 122 can be faster. Thus, such parameter can be chosen based on user preferences. In various cases, the set of parameters 304 can further include a parameter to indicate whether execution of the ensemble of quantum circuits 122 is to be distributed across multiple QPUs.

In any case, decomposition component 204 can receive the set of parameters 304 and the quantum channels 302 (e.g., the quantum channel circuit) as input, and decompose the quantum channels 302 into the ensemble of quantum circuits 122 based on the set of parameters 304. In various embodiments, the ensemble of quantum circuits 122 can comprise n quantum circuits, for any suitable positive integer n>1: a quantum circuit 122(1) to a quantum circuit 122(n).

In various embodiments, decomposition component 204 can use awareness of the noise in quantum computer 112 (e.g., noise models, calibration data) to decompose the quantum channels 302. This way, the decomposition component 204 can assure noise-robust decomposition of the quantum channels 302.

In various aspects, the decomposition component 204 can enable further customization of decomposition by using parameterized gates to decompose the quantum channels 302. The use of parameterized gates can also reduce noise susceptibility of the ensemble of quantum circuits 122. As an example, the parameterized gates can be decomposed using native pulse gates of the quantum computer 112 and virtual Rz gates.

FIG. 4 illustrates an example, non-limiting block diagram 400 showing how a quantum channel circuit is decomposed into an ensemble of quantum circuits in accordance with one or more embodiments described herein.

FIG. 4 illustrates a non-limiting example of decomposing quantum channel circuit 120 into the ensemble of quantum circuits 122 using QPD. Any of the quantum channels 302 can be defined by [symbol] =Σᵢwᵢεᵢ (e.g., 402) where w denotes weights assigned to the ensemble of quantum circuits 122, indexed by i. This can be further defined by

$$ℱ = {\sum }_{i} sgn ( {w}_{i} ) \frac{\vert {w}_{i} \vert}{} {ε}_{i} ,$$

where wᵢ∈ [symbol] , sgn(wᵢ)ϰ denotes correction factors of the ensemble of quantum circuits 122, and

$$\frac{\vert {w}_{i} \vert}{}$$

denotes probabilities of the ensemble of quantum circuits 122.

In other words, decomposition component 204 can determine how to decompose a quantum channel [symbol] in terms of quantum circuits ε (e.g., 404) and their respective weights w. Accordingly, in response to executing the quantum circuits ε (e.g., the ensemble of quantum circuits 122), the computation component 208 can combine the results from the execution of each quantum circuit εᵢ to determine the result of executing quantum channel [symbol] .

The optimal decomposition of the quantum channel [symbol] will minimize ϰ. In various aspects, the decomposition component 204 can determine pure probabilities or quasi-probabilities, which can be specified based on user input. For pure probabilities, all correction factors of the ensemble of quantum circuits 122 can equal 1, and thus ϰ=1. Conversely, for quasi-probabilities, the correction factors for each of the ensemble of quantum circuits 122 can differ, and thus ϰ is not necessarily 1.

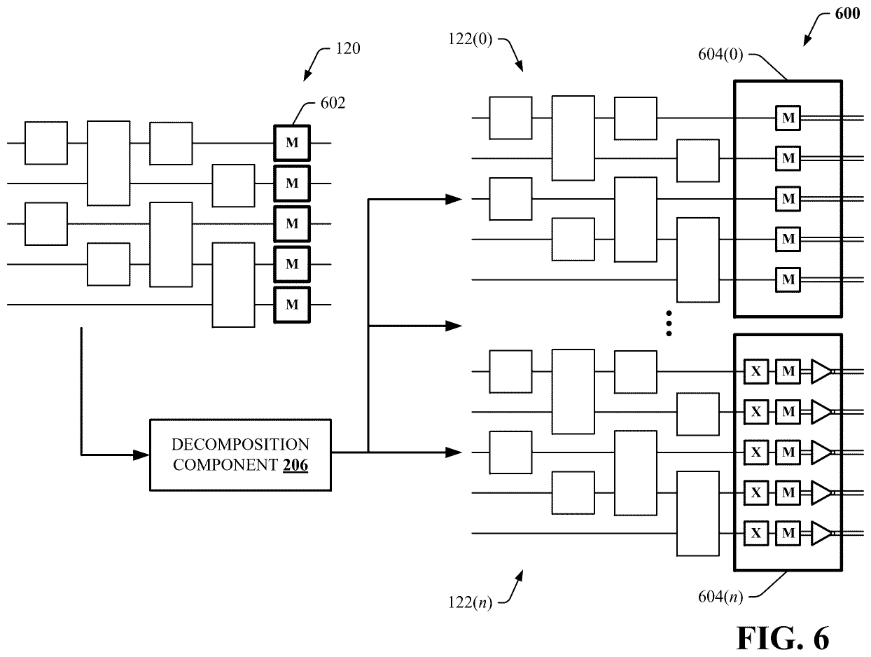

More specific examples of decomposing quantum channels 302 into the ensemble of quantum circuits 122 based on application are discussed with respect to FIGS. 6-12.

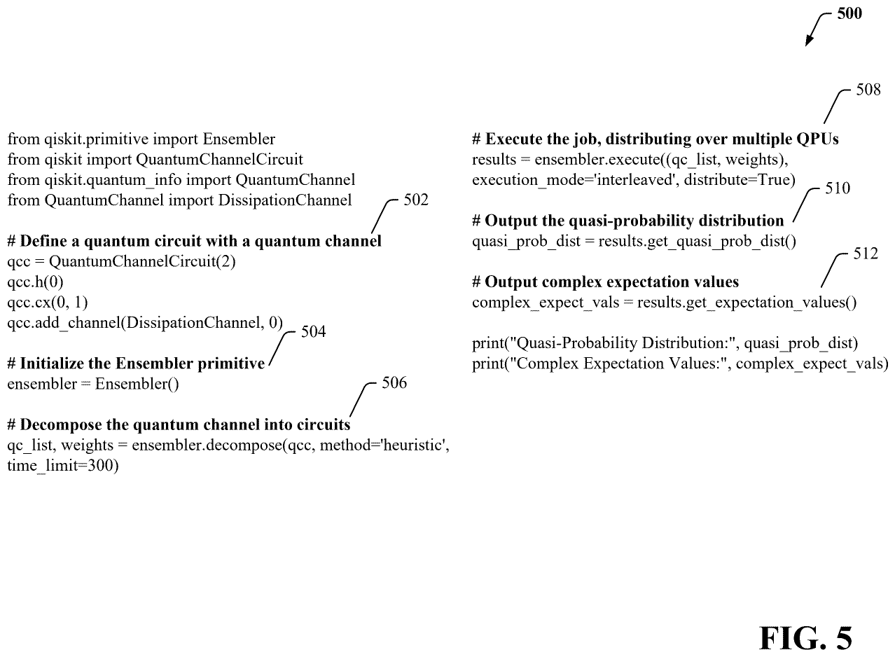

FIG. 5 illustrates an example, non-limiting base code implementation 500 for a quantum computational software primitive for general quantum channels in accordance with one or more embodiments described herein.

In various aspects, the various embodiments described herein can be implemented as an algorithmic primitive using the non-limiting base code implementation 500. In various embodiments, the algorithmic primitive for general quantum circuits can provide various core functions. With these core functions, a user can easily and efficiently implement any general quantum channel with any desired customizations, parameters, or settings.

More specifically, first using code block 502, the quantum channel circuit 120 can be defined with a quantum channel. The quantum channel circuit 120 is denoted by “qcc”.

Thereafter, using code block 504, the quantum channel circuit 120 can be initialized with the algorithmic primitive for general quantum circuits. The algorithmic primitive is denoted by “Ensembler”.

Following initialization of the quantum channel circuit 120, using code block 506, the quantum channel circuit 120 can be decomposed into the ensemble of quantum circuits 122. In code block 506, a user can input parameters 304 to customize the decomposition of the quantum channel circuit 120. In the non-limiting example of FIG. 5, the time limit 306 for decomposition of the quantum channel circuit 120 is set to 300 seconds, and the method for decomposition of the quantum channel circuit 120 is set to “heuristic”.

In any case, using code block 508, the ensemble of quantum circuits 122 can be executed on quantum computer 112. In code block 508, a user can input parameters or execution settings to customize the execution of the ensemble of quantum circuits 122. In the non-limiting example of FIG. 5, the execution method is set to “interleaved” and “true” for distributing. This means that the execution of the ensemble of quantum circuits 122 will be distributed over multiple QPUs, which can enable more efficient resource utilization and processing.

In code block 510, the results from executing the ensemble of quantum circuits 122 using code block 508 can be combined to determine a quasi-probability distribution of the quantum channel circuit 120.

Alternatively, using code block 512, the results from executing the ensemble of quantum circuits 122 using code block 508 can be combined to determine complex expectation values of the quantum channel circuit 120.

In various cases, code block 510 and code block 512 can be used together or separately depending on a desired input from the user. For example, the user can wish to obtain the quasi-probability distribution and the complex expectation values, only the quasi-probability distribution, or only the complex expectation values.

Non-limiting example applications of the algorithmic primitive for implementing general quantum channels described herein are now described with respect to FIGS. 6-12.

First, consider FIG. 6. FIG. 6 illustrates an example, non-limiting block diagram 600 of an example application for readout mitigation in accordance with one or more embodiments described herein.

Readout mitigation is a technique to correct errors that occur during measurement (readout) in quantum systems. Readout mitigation can be viewed as a classical post-processing quantum channel that applies a correction matrix to compensate for measurement errors.

For example, quantum channel circuit 120 can comprise measurement operators 602. Accordingly, using the algorithmic primitive for general quantum circuits described herein, the quantum channel circuit 120 can be automatically decomposed (e.g., without user involvement) into the ensemble of quantum circuits 122 comprising operations 604.

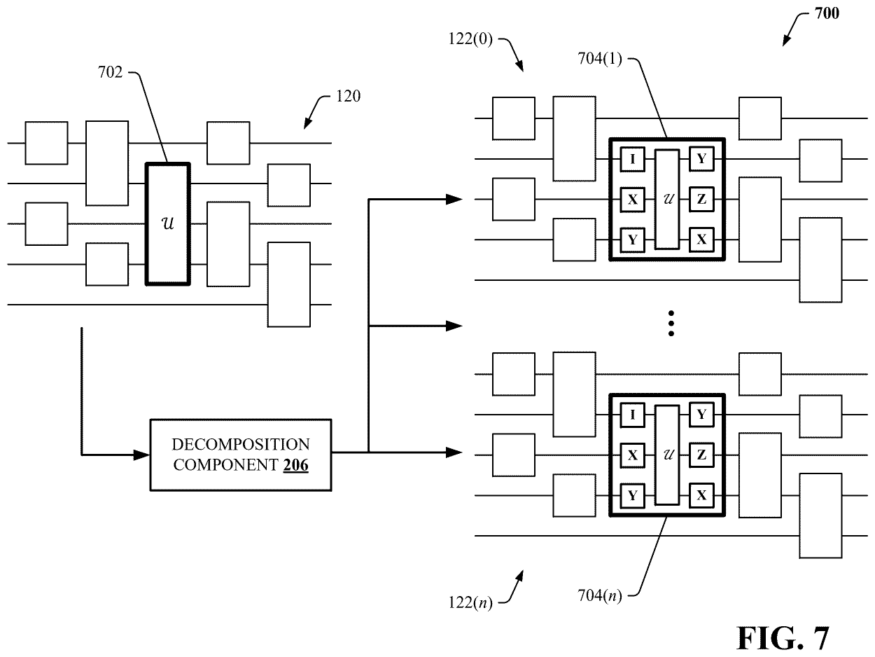

Next, consider FIG. 7. FIG. 7 illustrates an example, non-limiting block diagram 700 of an example application for twirling in accordance with one or more embodiments described herein.

Twirling is a technique that randomizes errors by applying unitary operations, converting them into stochastic noise that is easier to analyze and mitigate. In other words, twirling is a method for shaping and reducing noise in quantum circuits. Twirling is an operation that can be viewed as a quantum channel.

For example, quantum channel circuit 120 can comprise a twirled gate 702 (e.g., denoted by U). Accordingly, using the algorithmic primitive for general quantum circuits described herein, the quantum channel circuit 120 can be automatically decomposed into the ensemble of quantum circuits 122 such that each of the ensemble of quantum circuits 122 samples a different random gate. Since twirling is random compilation, this can successfully decompose the twirled gate 702.

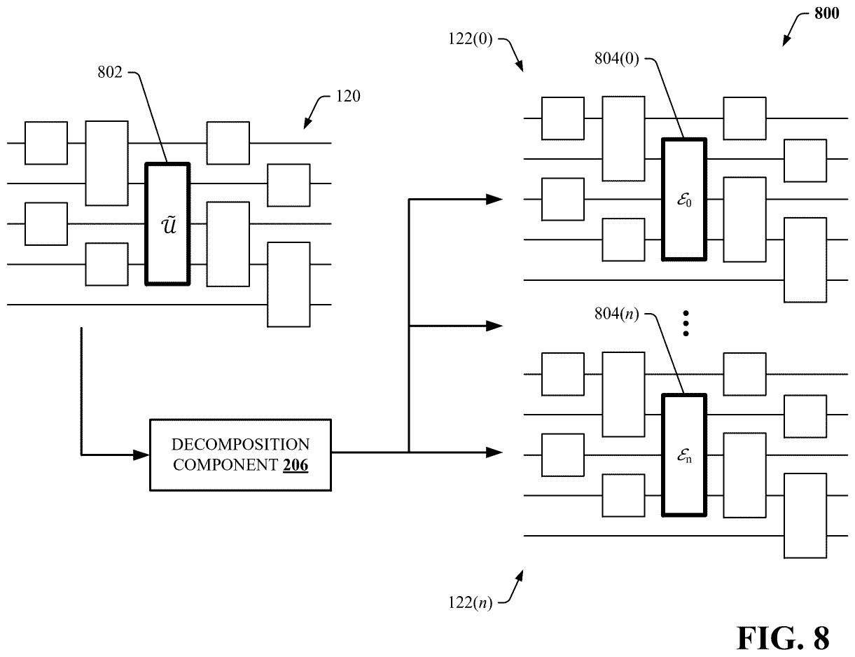

Next, consider FIG. 8. FIG. 8 illustrates an example, non-limiting block diagram 800 of an example application for compensation in accordance with one or more embodiments described herein.

Compensation, also known as Probabilistic Error Mitigation (PEM), is a method that corrects measurement errors by adjusting the observed outcomes using a predetermined error model. Compensation can be viewed as a quantum channel that applies a correction matrix to the measurement probabilities.

For example, quantum channel circuit 120 can comprise an approximate unitary operator 802 (e.g., denoted by U). Accordingly, using the algorithmic primitive for general quantum circuits described herein, the quantum channel circuit 120 can be automatically decomposed into the ensemble of quantum circuits 122 comprising operations 704.

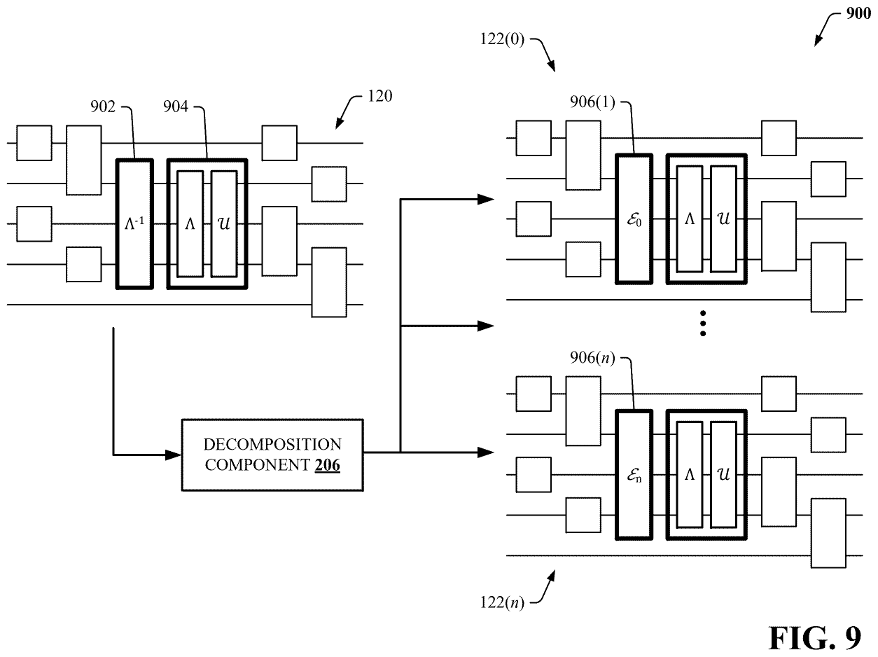

Next, consider FIG. 9. FIG. 9 illustrates an example, non-limiting block diagram 900 of an example application for inversion in accordance with one or more embodiments described herein.

Inversion is a process that inverts noise channels (Probabilistic Error Cancellation, PEC) or measurement errors (Post-Error Mitigation, PEM) to recover an error-free result. Inversion can be viewed as an inverse quantum channel that cancels the effects of noise by applying the inverse of the noise map.

For example, quantum channel circuit 120 can comprise an inverse noise channel 902 (e.g., denoted by Λ⁻¹) to mitigate noise introduced by noise channel A, recovering the ideal unitary U, shown in operation 904. Accordingly, using the algorithmic primitive for general quantum circuits described herein, the quantum channel circuit 120 can be automatically decomposed into the ensemble of quantum circuits 122 comprising operations 906.

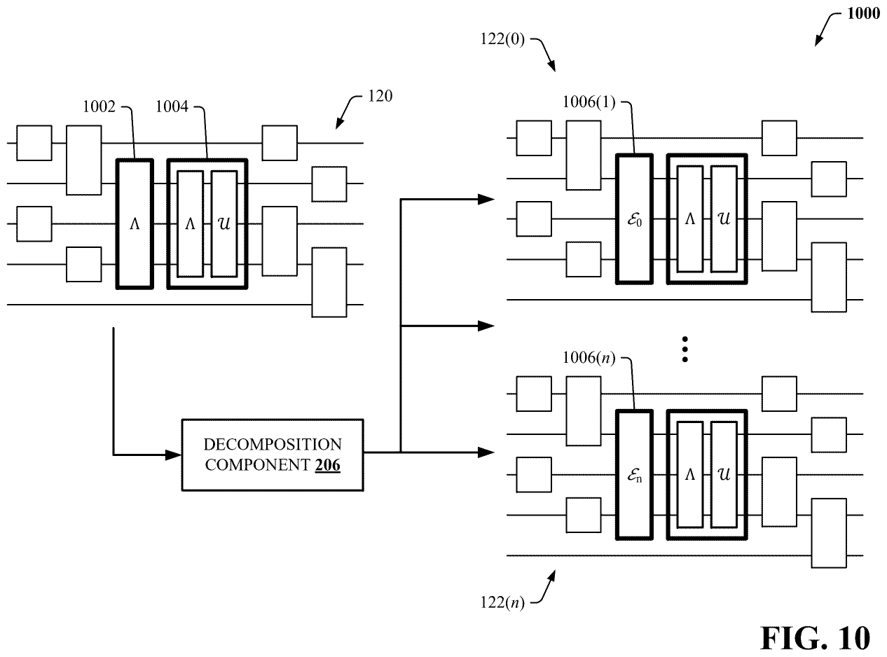

Next, consider FIG. 10. FIG. 10 illustrates an example, non-limiting block diagram 1000 of an example application for noise amplification in accordance with one or more embodiments described herein.

Amplification, or Probabilistic Error Amplification (PEA) is a technique that amplifies errors intentionally to estimate and mitigate their effects through extrapolation. It can be viewed as a quantum channel that scales noise processes to higher levels, enabling extrapolation to the zero-noise limit.

For example, quantum channel circuit 120 can comprise a noise channel 1002 (e.g., denoted by Λ) to amplify noise before noise channel Λ, recovering the ideal unitary U, shown in operation 1004. Accordingly, using the algorithmic primitive for general quantum circuits described herein, the quantum channel circuit 120 can be automatically decomposed into the ensemble of quantum circuits 122 comprising operations 1006.

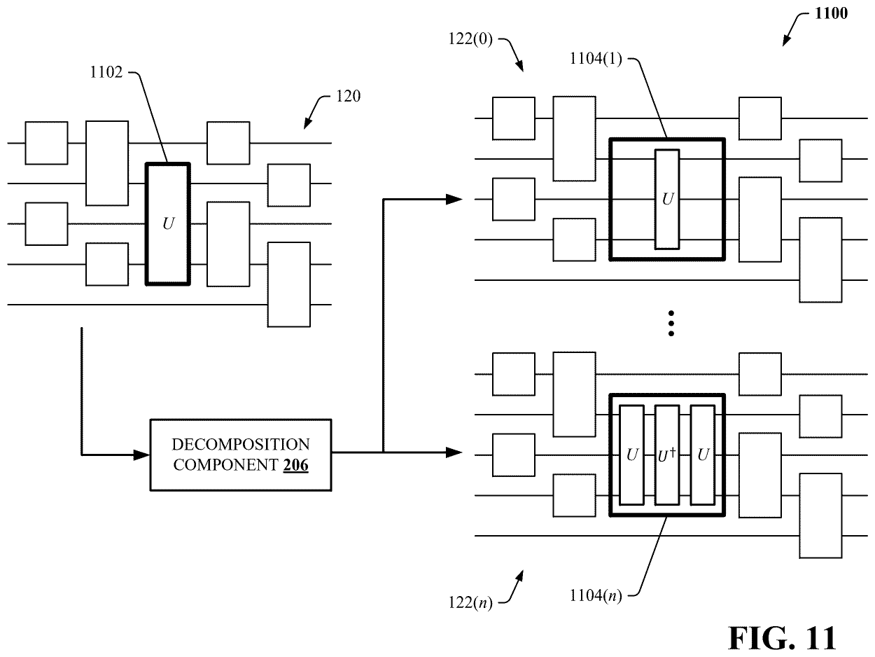

Next, consider FIG. 11. FIG. 11 illustrates an example, non-limiting block diagram 1100 of an example application for partial folding in accordance with one or more embodiments described herein.

Partial folding, also known as Xero Noise Extrapolation (ZNE), is an error mitigation procedure that adds noise to a quantum circuit. More specifically, partial folding is a noise scaling technique that applies fractions of unitary operations to scale errors without fully executing the circuit. It can be implemented as a quantum channel that interpolates between the identity and a unitary operator to scale noise.

For example, quantum channel circuit 120 can comprise a unitary operator 1102 (e.g., denoted by U). Accordingly, using the algorithmic primitive for general quantum circuits described herein, the quantum channel circuit 120 can be automatically decomposed into the ensemble of quantum circuits 122 comprising operations 1104, where the ensemble of quantum circuits 122 can comprise basis operations that are applied probabilistically.

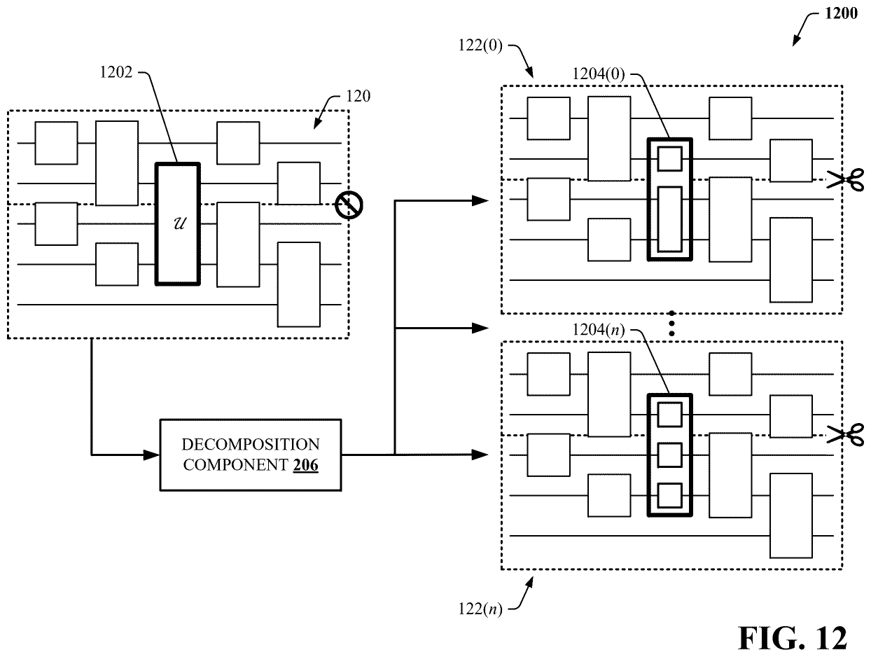

Lastly, consider FIG. 12. FIG. 12 illustrates an example, non-limiting block diagram 1200 of an example application for circuit cutting in accordance with one or more embodiments described herein.

Circuit cutting is a method that divides a large quantum circuit into smaller sub-circuits, enabling classical reconstruction of results to circumvent hardware limitations. It can be viewed as a quantum channel that maps the circuit into smaller fragments while maintaining the overall process through classical post-processing.

For example, quantum channel circuit 120 can comprise a unitary operator 1202 (e.g., denoted by U) that acts across three qubits. Accordingly, using the algorithmic primitive for general quantum circuits described herein, the quantum channel circuit 120 can be automatically decomposed into the ensemble of quantum circuits 122 comprising operations 1204 such that each of the ensemble of quantum circuits 122 acts on a subset of the three qubits (e.g., no longer requires simultaneous operation across all three qubits). Thus, the quantum channel circuit 120 can be split accordingly.

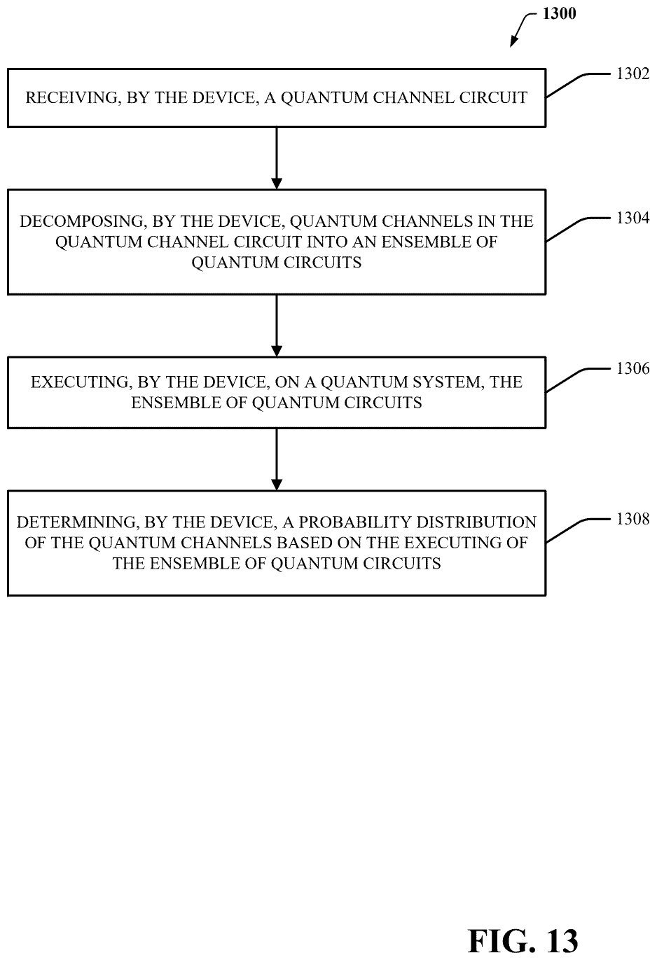

FIG. 13 illustrates a flow diagram of an example, non-limiting computer-implemented method 1300 that can facilitate a quantum computational software primitive for general quantum channels in accordance with one or more embodiments described herein. In various cases, the classical system 102 can facilitate the computer-implemented method 1300.

In various embodiments, act 1302 can include receiving, by a device (e.g., via 202) operatively coupled to a processor (e.g., 104), a quantum channel circuit (e.g., 120).

In various aspects, act 1304 can include decomposing, by the device (e.g., via 204), one or more quantum channels (e.g., 302) in the quantum channel circuit into an ensemble of quantum circuits (e.g., 122).

Although not explicitly shown in FIG. 13, the computer-implemented method 1300 can include receiving, by the device (e.g., via 202), parameters (e.g., 304) for decomposing the one or more quantum channels.

In various instances, act 1306 can include executing, by the device (e.g., via 206), the ensemble of quantum circuits on a quantum system (e.g., 112).

In various cases, act 1308 can include determining, by the device (e.g., via 208), a probability distribution of the one or more quantum channels based on the executing of the ensemble of quantum circuits.

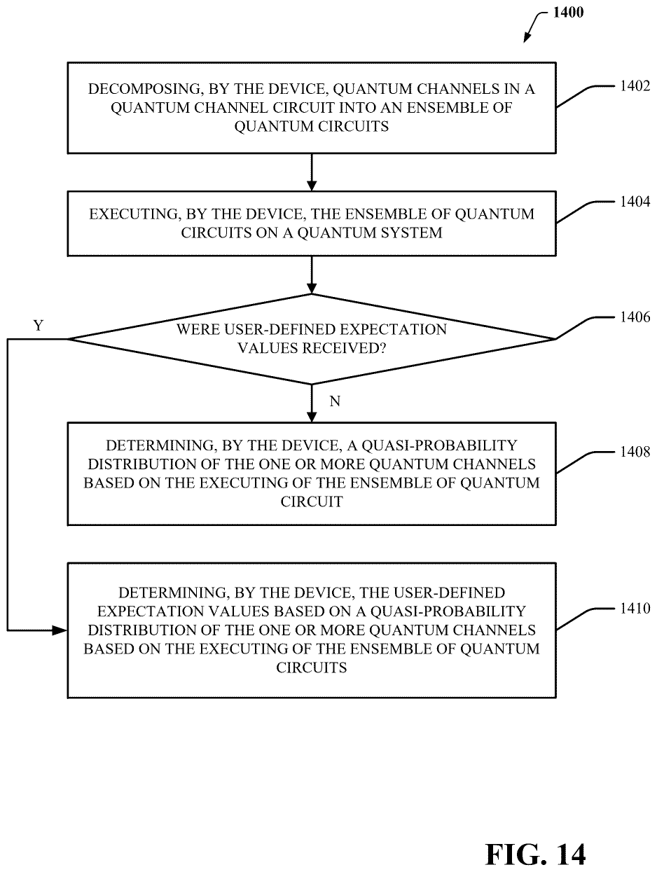

FIG. 14 illustrates a flow diagram of an example, non-limiting computer-implemented method 1400 that can facilitate a quantum computational software primitive for general quantum channels in accordance with one or more embodiments described herein. In various cases, the classical system 102 can facilitate the computer-implemented method 1400.

In various embodiments, act 1402 can include decomposing, by the device (e.g., via 204), one or more quantum channels (e.g., 302) in a quantum channel circuit (e.g., 120) into an ensemble of quantum circuits (e.g., 122).

In various aspects, act 1404 can include executing, by the device (e.g., via 206), the ensemble of quantum circuits on a quantum system (e.g., 112).

In various instances, act 1406 can include determining, by the device (e.g., via 204), if user-defined expectation values were received. If not, the computer-implemented method 1400 can proceed to act 1408. If so, the computer-implemented method 1400 can proceed to act 1410.

In various cases, act 1408 can include determining, by the device (e.g., via 208), a quasi-probability distribution of the one or more quantum channels based on the executing of the ensemble of quantum circuits.

In various cases, act 1410 can include determining, by the device (e.g., via 208), the user-defined expectation values based on a quasi-probability distribution of the one or more quantum channels based on the executing of the ensemble of quantum circuits.

FIG. 15 and the following discussion are intended to provide a brief, general description of a suitable computing environment 1500 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1500 contains an example of an environment for the execution of at least some of the computer code involved in performing the inventive methods, such as algorithmic primitive for general quantum channels code 1580. In addition to block 1580, computing environment 1500 includes, for example, computer 1501, wide area network (WAN) 1502, end user device (EUD) 1503, remote server 1504, public cloud 1505, and private cloud 1506. In this embodiment, computer 1501 includes processor set 1510 (including processing circuitry 1520 and cache 1521), communication fabric 1511, volatile memory 1512, persistent storage 1513 (including operating system 1522 and block 1580, as identified above), peripheral device set 1514 (including user interface (UI), device set 1523, storage 1524, and Internet of Things (IoT) sensor set 1525), and network module 1515. Remote server 1504 includes remote database 1530. Public cloud 1505 includes gateway 1540, cloud orchestration module 1541, host physical machine set 1542, virtual machine set 1543, and container set 1544.

COMPUTER 1501 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1530. As is well understood in the art of computer technology, and depending upon the technology, performance of a computer-implemented method can be distributed among multiple computers or between multiple locations. On the other hand, in this presentation of computing environment 1500, detailed discussion is focused on a single computer, specifically computer 1501, to keep the presentation as simple as possible. Computer 1501 can be located in a cloud, even though it is not shown in a cloud in FIG. 15. On the other hand, computer 1501 is not required to be in a cloud except to any extent as can be affirmatively indicated.

PROCESSOR SET 1510 includes one, or more, computer processors of any type now known or to be developed in the future. Processing circuitry 1520 can be distributed over multiple packages, for example, multiple, coordinated integrated circuit chips. Processing circuitry 1520 can implement multiple processor threads or multiple processor cores. Cache 1521 is memory that is located in the processor chip package(s) and is typically used for data or code that should be available for rapid access by the threads or cores running on processor set 1510. Cache memories are typically organized into multiple levels depending upon relative proximity to the processing circuitry. Alternatively, some, or all, of the cache for the processor set can be located “off chip.” In some computing environments, processor set 1510 can be designed for working with qubits and performing quantum computing.

Computer readable program instructions are typically loaded onto computer 1501 to cause a series of operational steps to be performed by processor set 1510 of computer 1501 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1521 and the other storage media discussed below. The program instructions, and associated data, are accessed by processor set 1510 to control and direct performance of the inventive methods. In computing environment 1500, at least some of the instructions for performing the inventive methods can be stored in block 1580 in persistent storage 1513.

COMMUNICATION FABRIC 1511 is the signal conduction path that allows the various components of computer 1501 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1512 is any type of volatile memory now known or to be developed in the future. Examples include dynamic type random access memory (RAM) or static type RAM. Typically, the volatile memory is characterized by random access, but this is not required unless affirmatively indicated. In computer 1501, the volatile memory 1512 is located in a single package and is internal to computer 1501, but, alternatively or additionally, the volatile memory can be distributed over multiple packages or located externally with respect to computer 1501.

PERSISTENT STORAGE 1513 is any form of non-volatile storage for computers that is now known or to be developed in the future. The non-volatility of this storage means that the stored data is maintained regardless of whether power is being supplied to computer 1501 or directly to persistent storage 1513. Persistent storage 1513 can be a read only memory (ROM), but typically at least a portion of the persistent storage allows writing of data, deletion of data and re-writing of data. Some familiar forms of persistent storage include magnetic disks and solid-state storage devices. Operating system 1522 can take several forms, such as various known proprietary operating systems or open-source Portable Operating System Interface type operating systems that employ a kernel. The code included in block 1580 typically includes at least some of the computer code involved in performing the inventive methods.

PERIPHERAL DEVICE SET 1514 includes the set of peripheral devices of computer 1501. Data communication connections between the peripheral devices and the other components of computer 1501 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1523 can include components such as a display screen, speaker, microphone, wearable devices (such as goggles and smart watches), keyboard, mouse, printer, touchpad, game controllers, and haptic devices. Storage 1524 is external storage, such as an external hard drive, or insertable storage, such as an SD card. Storage 1524 can be persistent or volatile. In some embodiments, storage 1524 can take the form of a quantum computing storage device for storing data in the form of qubits. In embodiments where computer 1501 is required to have a large amount of storage (for example, where computer 1501 locally stores and manages a large database) then this storage can be provided by peripheral storage devices designed for storing large amounts of data, such as a storage area network (SAN) that is shared by multiple, geographically distributed computers. IoT sensor set 1525 is made up of sensors that can be used in Internet of Things applications. For example, one sensor can be a thermometer and another sensor can be a motion detector.

NETWORK MODULE 1515 is the collection of computer software, hardware, and firmware that allows computer 1501 to communicate with other computers through WAN 1502. Network module 1515 can include hardware, such as modems or Wi-Fi signal transceivers, software for packetizing or de-packetizing data for communication network transmission, or web browser software for communicating data over the internet. In some embodiments, network control functions and network forwarding functions of network module 1515 are performed on the same physical hardware device. In other embodiments (for example, embodiments that utilize software-defined networking (SDN)), the control functions and the forwarding functions of network module 1515 are performed on physically separate devices, such that the control functions manage several different network hardware devices. Computer readable program instructions for performing the inventive methods can typically be downloaded to computer 1501 from an external computer or external storage device through a network adapter card or network interface included in network module 1515.

WAN 1502 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1503 is any computer system that is used and controlled by an end user (for example, a customer of an enterprise that operates computer 1501) and can take any of the forms discussed above in connection with computer 1501. EUD 1503 typically receives helpful and useful data from the operations of computer 1501. For example, in a hypothetical case where computer 1501 is designed to provide a recommendation to an end user, this recommendation would typically be communicated from network module 1515 of computer 1501 through WAN 1502 to EUD 1503. In this way, EUD 1503 can display, or otherwise present, the recommendation to an end user. In some embodiments, EUD 1503 can be a client device, such as thin client, heavy client, mainframe computer or desktop computer.

REMOTE SERVER 1504 is any computer system that serves at least some data or functionality to computer 1501. Remote server 1504 can be controlled and used by the same entity that operates computer 1501. Remote server 1504 represents the machine(s) that collect and store helpful and useful data for use by other computers, such as computer 1501. For example, in a hypothetical case where computer 1501 is designed and programmed to provide a recommendation based on historical data, then this historical data can be provided to computer 1501 from remote database 1530 of remote server 1504.

PUBLIC CLOUD 1505 is any computer system available for use by multiple entities that provides on-demand availability of computer system resources or other computer capabilities, especially data storage (cloud storage) and computing power, without direct active management by the scale. The direct and active management of the computing resources of public cloud 1505 is performed by the computer hardware or software of cloud orchestration module 1541. The computing resources provided by public cloud 1505 are typically implemented by virtual computing environments that run on various computers making up the computers of host physical machine set 1542, which is the universe of physical computers in or available to public cloud 1505. The virtual computing environments (VCEs) typically take the form of virtual machines from virtual machine set 1543 or containers from container set 1544. It is understood that these VCEs can be stored as images and can be transferred among and between the various physical machine hosts, either as images or after instantiation of the VCE. Cloud orchestration module 1541 manages the transfer and storage of images, deploys new instantiations of VCEs and manages active instantiations of VCE deployments. Gateway 1540 is the collection of computer software, hardware and firmware allowing public cloud 1505 to communicate through WAN 1502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1506 is similar to public cloud 1505, except that the computing resources are only available for use by a single enterprise. While private cloud 1506 is depicted as being in communication with WAN 1502, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1505 and private cloud 1506 are both part of a larger hybrid cloud.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
an input component that receives a quantum channel circuit;
a decomposition component that decomposes one or more quantum channels in the quantum channel circuit into an ensemble of quantum circuits;
an execution component that executes, on a quantum system, the ensemble of quantum circuits; and
a computation component that determines a probability distribution of the one or more quantum channels based on the executing of the ensemble of quantum circuits.

2. The system of claim 1, wherein the decomposition component receives parameters for decomposing the one or more quantum channels, wherein the parameters comprise a time limit for classical processing or decomposition settings.

3. The system of claim 1, wherein the decomposition component decomposes the one or more quantum channels globally across all of the one or more quantum channels in the quantum channel circuit.

4. The system of claim 1, wherein the decomposition component decomposes the one or more quantum channels locally, wherein each of the one or more quantum channels are decomposed into a set of quantum circuits.

5. The system of claim 1, wherein the decomposition component customizes decomposition by decomposing the one or more quantum channels using parameterized gates.

6. The system of claim 1, wherein the execution component executes the ensemble of quantum circuits in an interleaved manner.

7. The system of claim 1, wherein the execution component executes the ensemble of quantum circuits in a sequential manner.

8. The system of claim 1, wherein the execution component executes the ensemble of quantum circuits across one or more quantum processors.

9. The system of claim 1, wherein the probability distribution is a quasi-probability distribution.

10. The system of claim 9, wherein the probability distribution are expectation values that are user-defined based on the quasi-probability distribution.

11. The system of claim 10, wherein the computation component determines, via bootstrapping over shots, confidence intervals or error bars to quantify uncertainty in the quasi-probability distribution or the expectation values.

12. A computer-implemented method, comprising:
receiving, by a system operatively coupled to a processor, a quantum channel circuit;
decomposing, by the system, one or more quantum channels in the quantum channel circuit into an ensemble of quantum circuits;
executing, by the system, on a quantum system, the ensemble of quantum circuits; and
determining, by the system, a probability distribution of the one or more quantum channels based on the executing of the ensemble of quantum circuits.

13. The computer-implemented method of claim 12, further comprising:
receiving, by the system, parameters for decomposing the one or more quantum channels, wherein the parameters comprise a time limit for classical processing or decomposition settings.

14. The computer-implemented method of claim 12, further comprising:
decomposing, by the system, the one or more quantum channels globally across all of the one or more quantum channels in the quantum channel circuit.

15. The computer-implemented method of claim 12, further comprising:
decomposing, by the system, the one or more quantum channels locally, wherein each of the one or more quantum channels are decomposed into a set of quantum circuits.

16. The computer-implemented method of claim 12, further comprising:
executing, by the system, the ensemble of quantum circuits in an interleaved manner or a sequential manner.

17. The computer-implemented method of claim 12, further comprising:
executing, by the system, the ensemble of quantum circuits across one or more quantum processors.

18. The computer-implemented method of claim 12, wherein the probability distribution is a quasi-probability distribution.

19. A computer program product to provide a quantum computing primitive for executing quantum channels, the computer program product comprising a computer readable storage medium having program instructions embodied therewith, the program instructions executable by a processor to cause the processor to:
receive, by the processor, a quantum channel circuit;
decompose, by the processor, one or more quantum channels in the quantum channel circuit into an ensemble of quantum circuits;
execute, by the processor, on a quantum system, the ensemble of quantum circuits; and
determine, by the processor, a probability distribution of the one or more quantum channels based on the executing of the ensemble of quantum circuits.

20. The computer program product of claim 19, wherein the program instructions are further executable by the processor to cause the processor to:
decompose, by the processor, the one or more quantum channels globally across all of the one or more quantum channels in the quantum channel circuit.
